(19) United States
(12) Patent Application Publication
(10) Pub. No.: US 2010/0094514 A1
(43) Pub. Date: Apr. 15, 2010

(54) VEHICULAR SEAT OPERATION DEVICE AND VEHICULAR SEAT OPERATION METHOD

(75) Inventor: Katsuya Ueda, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi ,Aichi-ken (JP)

(21) Appl. No.: 12/449,367

(22) PCT Filed: Feb. 14, 2008
(86) PCT No.: PCT/IB2008/000333

§ 371 Date: Aug. 5, 2009

(30) Foreign Application Priority Data
Feb. 15, 2007 (JP) 2007-034627

(51) Int. Cl. B60N 2/44

(52) U.S. Cl. 701/49

(57) ABSTRACT

A vehicular seat operation device includes: a change device that changes a state of a vehicular seat; a permission device that permits a change to be made by the change device; a detection device that detects a change in the distribution of loads that act on the vehicular seat; and a control device that controls the change device by a predetermined change method corresponding to the change in the load distribution if the change by the change device has been permitted by the first permission device.

### BACKGROUND OF THE INVENTION

1. Field of the Invention

The invention relates to a vehicular seat operation device and a vehicle seat operation method. In particular, the invention relates to a vehicular seat operation device and a vehicle seat operation method for operating a vehicular seat such as an electric power seat or the like.

2. Description of the Related Art

Among vehicular seats, a so-called power seat is known which is equipped with an adjustment mechanism for the adjustment of the position of the vehicular seat in the vehicle front-rear direction, the adjustment of the reclining angle of the seatback, and the position adjustment in the vehicle up-down direction, and which adjusts these adjustment mechanisms by using electric motors or the like.

Japanese Utility Model Application Publication No. 5-62322 (JP-U-5-62322) proposes a switch for actuating each of adjustment mechanisms for a vehicular seat.

Furthermore, Japanese Patent Application Publication No. 2006-232088 (JP-A-2006-232088) proposes a technology that includes: driving position adjustment means for driving each of driving positions; load detection means for detecting the loads applied to load measurement sites; dissatisfaction behavior estimation means for estimating a dissatisfaction behavior in relation to a sitting posture on the basis of a change in the loads detected by the load detection means; and control means for driving the driving position adjustment means in such a direction as to resolve the dissatisfaction estimated by the dissatisfaction behavior estimation means, wherein if a driver feels dissatisfaction with the sitting posture while driving the vehicle, the site of the dissatisfaction is estimated on the basis of a change in the loads occurring at the load measurement sites, and the dissatisfying driving position is automatically adjusted so as to allow a driver to have a sitting posture that accords with the driver's intention.

However, in the technology described in Japanese Utility Model Application Publication No. 5-62322 (JP-U-5-62322), since the switches for adjusting various adjustment mechanisms are provided on a side surface of a vehicular seat, the design of the vehicular seat is sometimes restricted. Therefore, an improvement is desired in order to increase the degree of freedom in the design. Besides, since a plurality of switches are provided corresponding to various adjustment mechanisms, it is necessary to identify a switch that corresponds to an object of operation when an operation is to be performed. Therefore, an improvement is desired in order to attain a smooth operability that matches the occupant's intention.

In the technology described in Japanese Patent Application Publication No. 2006-232088 (JP-A-2006-232088), although a dissatisfaction behavior in conjunction with the sitting posture is estimated, there is possibility that when an occupant merely reseats himself or changes his sitting posture, or takes an action to look to the right and left, or the like, it may be determined that the occupant is dissatisfied about the sitting posture, and unintended adjustment of the vehicular seat may be performed. In this respect, too, an improvement is desired.

### SUMMARY OF THE INVENTION

The invention provides a vehicle seat operation device and a vehicle seat operation method which improve the degree of freedom in the design of a vehicular seat and also realize an operability thereof that suites the intention of an occupant.

A vehicular seat operation device of a first aspect of the invention includes: a change device that changes a state of a vehicular seat; a permission device that permits a change to be made by the change device; a detection device that detects a change in a load distribution of load that acts on the vehicular seat; and a control device that controls the change device by a predetermined change method corresponding to the change in the load distribution detected by the detection device if the change by the change device has been permitted by the permission device.

According to the foregoing aspect of the invention, the change device changes the state of the vehicular seat. For example, the change device may change the state of the vehicular seat by changing at least one of a position of the vehicular seat in a vehicle front-rear direction, a position of the vehicular seat in a vehicle left-right direction, a position of the vehicular seat in a vehicle up-down direction, a pivot angle of the vehicular seat, a hold angle of a side support of the vehicular seat, and an inclination angle of a seatback of the vehicular seat.

The permission device permits the change to be made by the change device. That is, if the change by the change device is not permitted by the permission device, the change by the change device is prohibited.

Furthermore, the detection device detects a change in the load distribution of loads acting on the vehicular seat. The detection device, for example, may detect a load shift state of a seated occupant as the change in the load distribution.

Then, in the control device, the change device is controlled by a predetermined change method corresponding to the change in the load distribution if the change by the change device has been permitted by the permission device. Specifically, since the shifting of load by an occupant changes the load distribution, and since the state of the vehicular seat can easily be changed by controlling the change device by a change method (concerning the site where the state of the vehicular seat is to be changed, the direction of such change, etc.) predetermined corresponding to a change in the load distribution, it is possible to easily operate the vehicular seat.

Furthermore, since the state of the vehicular seat can be changed only when the change by the change device is permitted by the permission device, the state of vehicular seat is not changed in response to a change in the distribution of the load applied to the vehicular seat during the running of the vehicle. Therefore, operability that suits the occupant's intention can be obtained.

The operation switch may be a switch that corresponds only to the permission device. Therefore, the design of the vehicular seat can not be restricted, and the degree of freedom in the design of the vehicular seat can be improved.

For example, the control device may control the change device if the load distribution becomes such that a difference between the load acting on a predetermined site in the vehicular seat and the load acting on another site is greater than or equal to a predetermined value. Therefore, there does not occur an event in which changes by different change methods alternately occur within a short time, such as the chattering of the shift in the vehicle front-rear direction, or the like. Thus, the chattering of the control can be prevented.

The detection device may include a load distribution sensor that is disposed in a seat base of the vehicular seat and that detects the load distribution, and a computation device that computes the change in the load distribution on the seat base based on a detection result from the load distribution sensor, or may also include a plurality of load sensors that are disposed below the vehicular seat and that detect load, and a computation device that computes the change in the load distribution of loads occurring on the plurality of load sensors based on detection results from the load sensors. For example, an airbag device or the like is provided with a load distribution sensor disposed in an seat base, a plurality of load sensors disposed below the seat base and adjustment devices, etc. so as to detect the sitting of an occupant. Therefore, the sensors provided for use for the airbag device may also be used by the computation device as well in order to calculate the load distribution. This makes it possible to construct the vehicular seat operation device at low cost without separately providing a sensor.

Furthermore, the vehicular seat operation device may further include a setting device that sets a reference value of the load distribution, and the detection device may detect the change in the load distribution from the reference value. Specifically, the load distribution while an occupant is seated may sometimes vary depending on the state of the vehicular seat. If a load distribution that serves as a reference is set by the setting device, it becomes possible to detect such a change in the load distribution.

Furthermore, in the vehicular seat operation device of the first aspect, the change device may include a first change device and a second change device that shift the vehicular seat in one method and another method that is different from the one method, respectively. The permission device may select one of the first change device and the second change device, and permits the selected one of the first change device and the second change device to shift the vehicular seat.

The provision of the above described permission device makes it possible to operate a plurality of change devices. In this case, the vehicular seat operation device may further include a display device that indicates that shifting of the vehicular seat by the first change device has been permitted if the permission device has selectively permitted the first change device to shift the vehicular seat. The provision of the display device in this manner makes it possible for a seated occupant to recognize an object to be operated.

According to a vehicular seat operation method of a second aspect of the invention, a reference load distribution is calculated based on loads acting on a vehicular seat, and it is determined whether or not a change of a set position of the vehicular seat has been permitted, and it is determined whether or not an amount of change in the load distribution calculated relative to the reference load distribution is greater than a predetermined value. If it is determined that the change has been permitted and that the amount of change in the load distribution is greater than the predetermined value, the vehicular seat is shifted in a predetermined direction that corresponds to a pattern of the change in the load distribution calculated relative to the reference load distribution.

In the second aspect of the invention, if it is determined that the change in the set position of the vehicular seat has been permitted, it may be determined whether or not which of a plurality of modes that each define a shift manner of the vehicular seat has been selected. Then, the vehicular seat may be shifted in the predetermined direction that corresponds to the pattern of the calculated change in the load distribution by controlling a change device provided for the vehicular seat which has been associated in correspondence to the mode determined to have been selected.

According to the aspects of the invention as described above, a change in the distribution of loads acting on the vehicular seat is detected. If a change of the state of the vehicular seat is permitted, the state of the vehicular seat is shifted and controlled by a change method predetermined corresponding to a change in the load distribution detected. Therefore, the invention achieves advantages of improving the degree of freedom in the design of the vehicular seat, and of realizing an operability that suits an occupant's intention.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a diagram showing a skeleton structure of a vehicular seat in accordance with an embodiment of the invention;

FIG. 2 is a block diagram showing a construction of the vehicular seat operation device in accordance with a first embodiment of the invention;

FIG. 3A shows an example of the initial-state load distribution;

FIG. 3B shows an example of the load distribution in the case where the load distribution in a forward side of the vehicular seat increases;

FIG. 3C shows an example of the load distribution in the case where the load distribution in a rearward side of the vehicular seat increases;

FIG. 4A is a diagram for describing the shift of the vehicular seat to a vehicle forward side;

FIG. 4B is a diagram for describing the shift of the vehicular seat to a vehicle rearward side;

FIG. 5 is a flowchart showing an example of the flow of a process performed by a power seat control ECU of a vehicular seat operation device in accordance with the first embodiment of the invention;

FIG. 6A is a diagram showing the reclining of the vehicular seat;

FIG. 6B is a diagram showing an example of a mechanism for the upward-downward shift of the vehicular seat;

FIG. 7 is a block diagram showing a construction of a vehicular seat operation device in accordance with a second embodiment of the invention;

FIG. 8A is a diagram showing an example in which a spoke portion of a steering wheel is provided with a mode change switch;

FIG. 8B is a diagram showing an example in which a display is provided within a combination meter;

FIG. 8C is a diagram showing an example in which the state in which the mode change switch has been operated is displayed;

FIG. 9 is a flowchart showing an example of the flow of a process performed by a power seat control ECU of a vehicular seat operation device in accordance with the second embodiment of the invention;

FIG. 10 is a diagram showing an example in which an occupant shifts his own load in the vehicle left-right direction so as to control the shifting of the vehicular seat in the vehicle left-right direction;

FIGS. 11A and 11B are diagrams showing an example in which an occupant shifts his own load by twisting his body so as to control the rotation of the vehicular seat in the vehicle left-right direction;

FIG. 12 is a diagram showing an example of the load distribution in the case where an occupant shifts his own load in the vehicle left-right direction; and

FIG. 13 is a diagram showing an example of the load distribution in the case where an occupant shifts his own load by twisting his body.

### DETAILED DESCRIPTION OF THE EMBODIMENTS

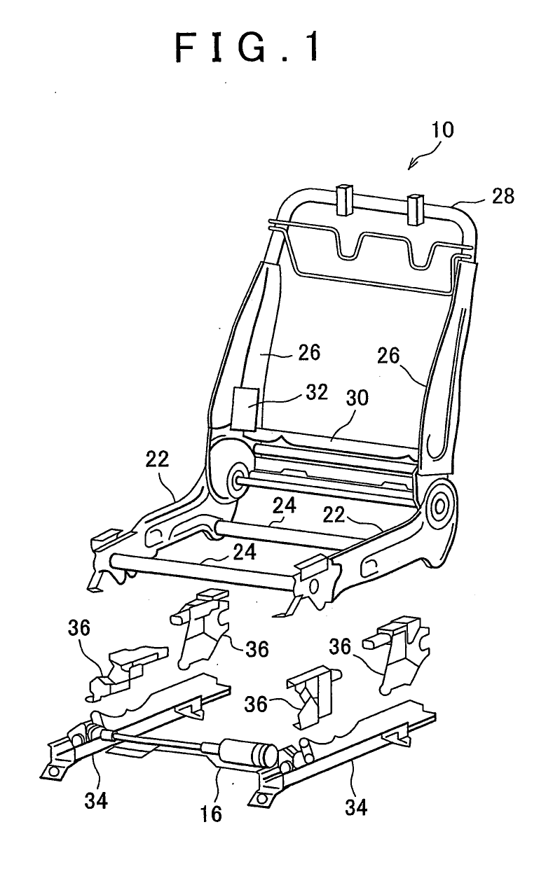

Hereinafter, example embodiments of the invention will be described with reference to the drawings. FIG. 1 is a diagram showing a skeleton structure of a vehicular seat in accordance with an embodiment of the invention.

As shown in FIG. 1, in a vehicular seat 10 in accordance with an embodiment of the invention, a frame of a seat cushion that forms a seat base is formed by linking a pair of seat cushion side frames 22 via a plurality of rod-shape joint bars 24.

Furthermore, a frame of a seatback that forms a backrest is formed by linking a pair of seatback side frames 26 via a seatback linking member 28 and also linking them via a seatback reinforcing member 30.

The frame of the seat cushion and the frame of the seatback are linked so that the seatback frame is rotatable relative to the seat cushion frame. The vehicular seat 10 further includes a reclining motor 32 for rotating the seatback frame. Specifically, the seatback frame is pivoted relative to the seat cushion frame by the reclining motor 30 via gears or the like.

A pair of seat rails 34 for shifting the vehicular seat 10 in the vehicle front-rear direction is provided at a location that is below the seat cushion frame with respect to the vehicle. The seat cushion frame and the seat rails 34 are connected via four seat brackets 36.

The seat rails 34 are provided with a forward-rearward shift motor 16. The vehicular seat 10 can be shifted in the vehicle front-rear direction by the forward-rearward shift motor 16 via gears or the like.

### First Embodiment

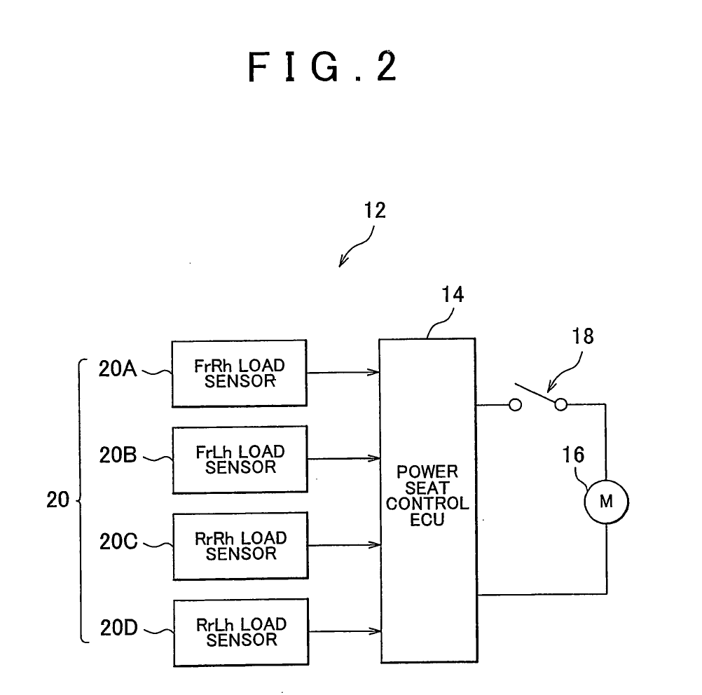

Subsequently, a vehicular seat operation device 12 in accordance with a first embodiment of the invention will be described. FIG. 2 is a block diagram showing a construction of the vehicular seat operation device 12 in accordance with the first embodiment of the invention.

The vehicular seat control device 12 in accordance with this embodiment includes a power seat control ECU (Electronic Control Unit) 14 that controls the shift of the vehicular seat 10 in the position in the front-rear direction. By controlling the shift of the vehicular seat 10 via the power seat control ECU 14, the position of the vehicular seat 10 in the vehicle front-rear direction is adjusted.

The forward-rearward shift motor 16 is connected to the power seat control ECU 14. By controlling the driving of the forward-rearward shift motor 16, the forward-rearward shift of the vehicular seat 10 is controlled.

Furthermore, a mode change switch 18 for permitting the driving of the forward-rearward shift motor 16 in order to shift the vehicular seat 10 is connected to the power seat control ECU 14. The mode change switch 18 has a fix mode and an operation mode. The fix mode prohibits the shifting adjustment of the vehicular seat 10 in the front-rear direction, and the operation mode permits the shifting adjustment of the vehicular seat 10 in the front-rear direction.

Furthermore, a plurality of load sensors 20 are connected to the power seat control ECU 14. The load sensors 20 are provided for each of the seat brackets 36 in this embodiment. In this embodiment, four load sensors 20 are provided. The four load sensors 20 are an FrRh load sensor 20A provided on the seat bracket 36 disposed at a front right-hand side relative to the vehicle, an FrLh load sensor 20B provided on the vehicle front left-hand side seat bracket 36, an RrRh load sensor 20C provided on the vehicle rear right-hand side seat bracket 36, and an RrLh load sensor 20D provided on the vehicle rear left-hand side seat bracket 36.

Each load sensor 20, which may be, for example, a strain gage or the like, detects the load applied to a corresponding one of the seat brackets 36, and outputs a result of detection to the power seat control ECU 14. Incidentally, the load sensors 20 for this use may be the ones that are provided for the use for the control of an airbag device. Such dual-purpose use of the sensors allows inexpensive construction of the vehicular seat operation device. Besides, various types of load sensors may be applied. Examples of the applicable types of load sensors include a type in which the load distribution on the seat base is detected by a load distribution sensor that is provided in the seat cushion for detecting the load distribution, a type in which the load is detected by a plurality of load sensors provided between the seat rails 34 and the vehicular seat 10 for detecting the load as in the embodiment, etc.

The power seat control ECU 14 calculates a change in the distribution of the load applied to the seat cushion on the basis of the results of detection from the load sensors 20, and controls the shift of the vehicular seat 10 in the front-rear direction in accordance with the calculated change in the load distribution.

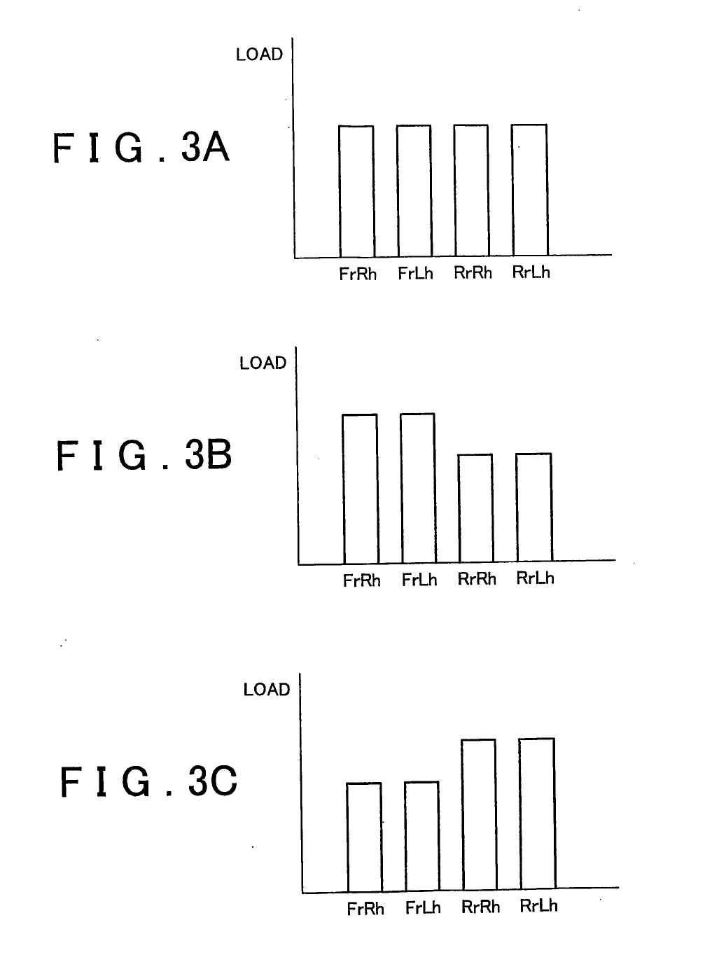

For example, let it assumed that the load distribution during an initial state is substantially the same result of detection being obtained from the load sensors 20 as shown in FIG. 3A. Then, if the loads on the forward side of the vehicular seat 10 are larger as shown in FIG. 3B (if the loads detected by the FrRh load sensor 20A and the FrLh load sensor 20B are larger than the loads detected by the RrRh load sensor 20C and the RrLh load sensor 20D), the power seat control ECU 14 determines that the vehicular seat 10 is to be shifted to the vehicle forward side, and controls the forward-rearward shift motor 16 so as to shift the vehicular seat 10 to the vehicle forward side.

Conversely, if the loads on the rearward side of the vehicular seat 10 are larger as shown in FIG. 3C (if the loads detected by the RrRh load sensor 20C and the RrLh load sensor 20D are larger than the loads detected by the FrRh load sensor 20A and the FrLh load sensor 20B), the power seat control ECU 14 determines that the vehicular seat 10 is to be shift to the vehicle rearward side, and controls the forward-rearward shift motor 16 so as to shift the vehicular seat 10 to the vehicle rearward side.

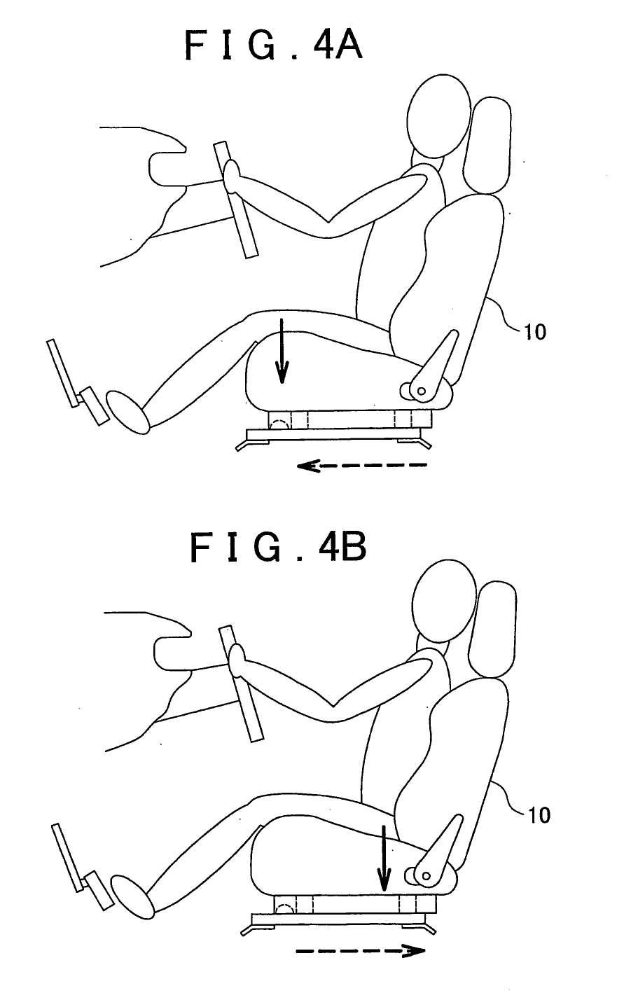

That is, the shift of the vehicular seat 10 in the front-rear direction can be controlled in accordance with how an occupant applies load to the vehicular seat 10. Therefore, as shown in FIG. 4A, an occupant can command a shift of the vehicular seat 10 to the vehicle forward side by applying load to the vehicle forward side of the vehicular seat 10, and as shown in FIG. 4B, the occupant can command a shift of the vehicular seat 10 to the vehicle rearward side by applying load to the vehicle rearward side of the vehicular seat 10. Thus, the operation can be made easy.

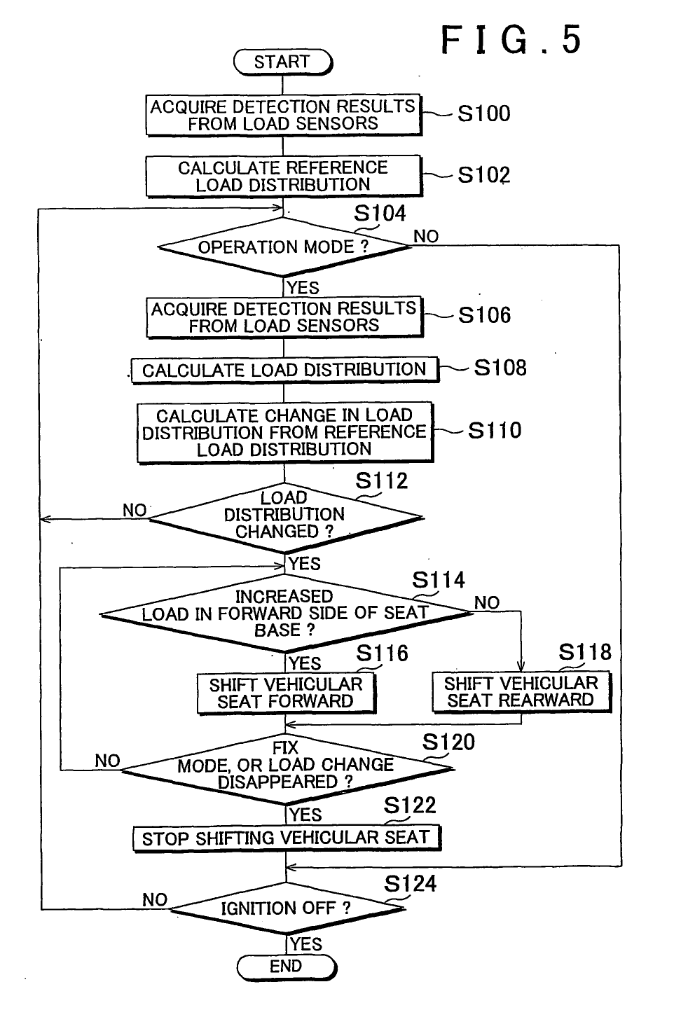

Next, processes performed by the power seat control ECU 14 of the vehicular seat operation device 12 in accordance with the first embodiment of the invention constructed as described will be described in detail. FIG. 5 is a flowchart showing an example of the flow of a process performed by the power seat control ECU 14 of the vehicular seat operation device 12 in accordance with the first embodiment of the invention. Although in the flowchart of FIG. 5, it is assumed that the process starts when an ignition switch (not shown) is turned on, this is not restrictive. For example, the process may start when an occupant is seated on the vehicular seat 10.

When an occupant turns on the ignition switch, the power seat control ECU 14, firstly in step 100, acquires detection results from the load sensors 20, and then proceeds to step 102.

In step 102, the power seat control ECU 14 calculates a reference load distribution, and then proceeds to step 104. Specifically, there are cases where the detection results from the load sensors 20 are not substantially the same and the load distribution that serves as a reference may vary depending on the present angle of the seatback of the vehicular seat 10 or the like. Therefore, on the basis of the detection results from the load sensors 20, the power seat control ECU 14 calculates a distribution of the loads applied to the seat cushion of the vehicular seat 10 that serves as a reference distribution. For example, in the example case shown FIGS. 3A to 3C, the load distribution that serves as a reference is substantially the same detection result being obtained from the load sensors 20 as shown in FIG. 3A.

Next in step 104, the power seat control ECU 14 determines whether or not the present mode is the operation mode. This determination is carried out by determining whether or not the mode change switch 18 has been operated by the occupant so as to command the operation mode. If a negative determination is made in this step, the process proceeds to step 124. If an affirmative determination is made, the process proceeds to step 106.

In step 106, the power seat control ECU 14 acquires detection results from the load sensors 20, and then proceeds to step 108.

In step 108, the power seat control ECU 14 calculates a load distribution, and then proceeds to step 110.

In step 110, the power seat control ECU 14 calculates a change in the load distribution from the reference load distribution, and then proceeds to step 112. For example, the change in the load distribution is calculated by the power seat control ECU 14 finding a difference between the reference load distribution calculated in step 102 and the load distribution calculated in step 108.

In step 112, the power seat control ECU 14 determines whether or not there is a change in the load distribution. If a negative determination is made in this step, the process returns to step 104, and the foregoing process is repeated. If an affirmative determination is made, the process proceeds to step 114.

In step 114, the power seat control ECU 14 determines whether or not the change in the load distribution is a load increase in the forward side of the seat base. If an affirmative determination is made in this step, the process proceeds to step 116. If a negative determination is made, it is determined that the change in the load distribution is a load increase in the rearward side of the seat base, and the process proceeds to step 118.

In step 116, the vehicular seat 10 is shifted to the vehicle forward side. Then, the process proceeds to step 120. Specifically, the power seat control ECU 14 controls the driving of the forward-rearward shift motor 16 so that the vehicular seat 10 is shifted to the vehicle forward side.

On the other hand, in step 118, the vehicular seat 10 is shifted to the vehicle rearward side. Then, the process proceeds to step 120. Specifically, the power seat control ECU 14 controls the driving of the forward-rearward shift motor 16 so that the vehicular seat 10 is shifted to the vehicle rearward side.

Incidentally, as for the determination regarding the load increase in the forward side of the seat base in the step 114, it may be determined whether or not, for example, the difference between the load distribution in the vehicle forward side of the vehicular seat 10 and the load distribution in the rearward side thereof is greater than or equal to a predetermined value. This makes it possible to prevent the chattering of the control in which a shift in the vehicle front direction and a shift in the vehicle rear direction are repeated in a short time.

Subsequently in step 120, the power seat control ECU 14 determines whether or not the fix mode has been selected or whether or not the load change has disappeared. Specifically, the power seat control ECU 14 determines whether or not the position of the vehicular seat 10 has been set and the mode change switch 18 has been switched to the fix mode, or whether or not the change in the load distribution has disappeared and the occupant has stopped shifting load. If a negative determination is made, the process returns to step 114, and the foregoing process is repeated. When an affirmative determination is made in step 120, the process proceeds to step 122, in which the power seat control ECU 14 stops the driving of the forward-rearward shift motor 16, so that the shift of the vehicular seat 10 stops.

Then in step 124, the power seat control ECU 14 determines whether or not the ignition switch has been turned off. If a negative determination is made in this step, the process returns to step 104, and the foregoing process is repeated. If an affirmative determination is made, the series of processes ends.

Thus, the vehicular seat operation device 12 in accordance with the embodiment is able to shift the vehicular seat 10 in the front-rear direction merely by an occupant shifting load toward the vehicle front or rear side while being seated. Therefore, the position adjustment of the vehicular seat 10 in the vehicle front-rear direction can easily be performed.

Furthermore, the vehicular seat operation device 12 shifts the vehicular seat 10 in response to a change in the load applied to the vehicular seat 10 only when the mode change switch 18 is operated to select the operation mode. While the mode change switch 18 is set for the fix mode, the position adjustment of the vehicular seat 10 is prohibited. Therefore, the vehicular seat operation device 12 can prevent the position adjustment of the vehicular seat 10 being performed in response to a load change or the like during the running of the vehicle.

Furthermore, since it is not necessary that the vehicular seat 10 be provided with a switch or the like for commanding a direction of the position adjustment of the vehicular seat 10, the degree of freedom in the design of the vehicular seat 10 can be improved.

Therefore, it is possible to improve the degree of freedom in the design of the vehicular seat and also realize the operability that suits an occupant's intention.

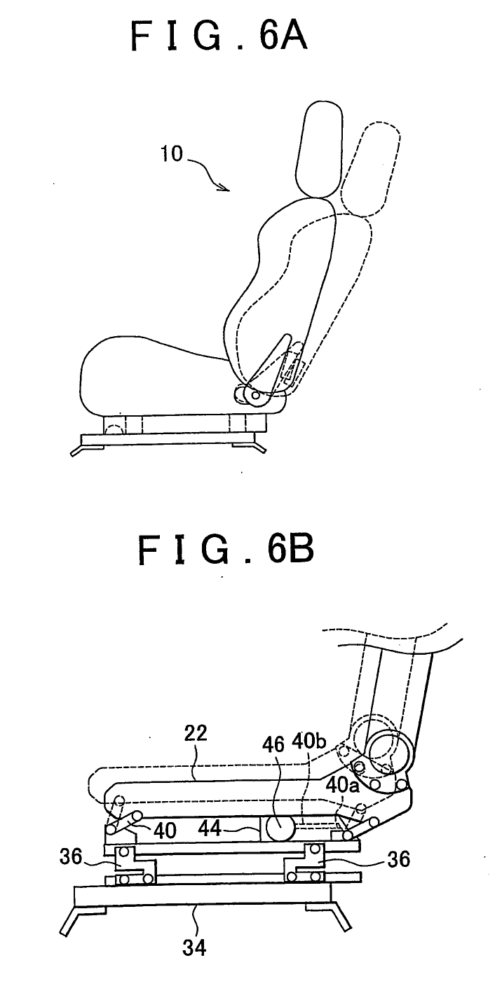

Although the first embodiment has been described in conjunction with the case where the vehicular seat 10 is adjusted in the position in the vehicle front-rear direction, this is not restrictive. For example, the embodiment may also be applied to the cases where the vehicular seat is adjusted in the position in the vehicle front-rear direction, the position in the vehicle left-right direction, the position in the vehicle up-down direction, the pivot angle, the hold angle of the side support, the inclination angle of the seatback, etc. For example, by controlling the driving of the reclining motor 32, the vehicular seat operation device 12 may adjust the inclination of the seatback as shown by a solid line and a dotted line in FIG. 6A. That is, the embodiment may also be applied to the adjustment of the reclining angle. In this case, for example, the seatback may be shifted in such a direction as to stand upright (a direction from the dotted line to the solid line in FIG. 6A) if the distribution of the load applied to the vehicular seat 10 changes so that the load distribution in the vehicle forward side increases as shown in FIG. 3B, and the seatback may be shifted in such a direction as to lie down (a direction from the solid line to the dotted line in FIG. 6A) if the load distribution changes so that the load distribution in the vehicle rearward side of the vehicular seat 10 increases as shown in FIG. 3C.

Furthermore, the embodiment may also be applied to the case where the position of the vehicular seat 10 in the vehicle up-down direction is adjusted. In this case, the adjustment mechanism for the position of the vehicular seat 10 in the vehicle up-down direction may be constructed, for example, as shown in FIG. 6B. In the construction shown, the seat cushion side frames 22 are connected to the seat rails 34 via link members 40 and seat brackets 36. The seat cushion side frames 22 are shifted via the link members 40 in the vehicle up-down direction as shown by solid lines and dotted lines in FIG. 6B. Each of the link member 40 is provided so as to be rotatable about an end thereof that is closer to an adjacent one of the seat brackets 36 disposed on the seat rails 34. Thus, the vehicular seat 10 is supported at four sites on the seat rails 34. The two link members 40 on the vehicle rearward side are interconnected by a lifter rod (not shown) at rotation-center portions in the ends of the link members 40. Thus, the two rearward-side link members 40 are rotated by rotating the lifter rod. The lifter rod is connected to a unit 44 that includes a lifter screw 40b connected to the lifter rod via a rotating link 40a provided for rotating the lifter rod, a worm gear provided for rotating the lifter screw 40b, etc. The unit 44 is provided with an up-down shift motor 46. By driving the up-down shift motor 46, the vehicular seat 10 is shifted in the vehicle up-down direction. Specifically, as the up-down shift motor 46 rotates, the worm gear in the unit 44 is rotated so that the lifter screw 40b meshing with the worm gear is shifted in the vehicle front-rear direction. Therefore, the rotating link 40a connected to the distal end of the lifter screw 40b is rotated by the shift of the lifter screw 40b in the vehicle front-rear direction, so that the lifter rod rotates and therefore shifts the link members 40 from a position shown by the solid lines and to a position shown by the dotted lines in FIG. 6B. Then, for example, in the case where the distribution of the load applied to the vehicular seat 10 changes so that the load distribution in the vehicle forward side increases as shown in FIG. 3B, the vehicular seat 10 is shifted in the vehicle upward direction (a direction from the solid lines to the dotted lines in FIG. 6B). Conversely, in the case where the load distribution in the vehicle rearward side increases as shown in FIG. 3C, the vehicular seat 10 is shifted in the vehicle downward direction (a direction from the dotted lines to the solid lines in FIG. 6B).

Incidentally, the adjustment mechanism of the vehicular seat is not limited to the foregoing constructions. On the contrary, various known technologies can be applied to the adjustment mechanism.

### Second Embodiment

Next, a vehicular seat operation device in accordance with a second embodiment of the invention will be described.

While in the description of the first embodiment the position of the vehicular seat 10 is adjusted in the vehicle front-rear direction, a plurality of kinds of adjustment are performed in the second embodiment. Concretely, in this embodiment, the vehicular seat 10 is adjusted in the position in the vehicle front-rear direction, the position in the vehicle up-down direction, and the reclining angle. With regard to the adjustment mechanisms, the adjustment mechanisms illustrated in FIGS. 1 and 6 may be applied, and other known adjustment mechanisms may also be applied. Therefore, detailed descriptions of the adjustment mechanisms are omitted.

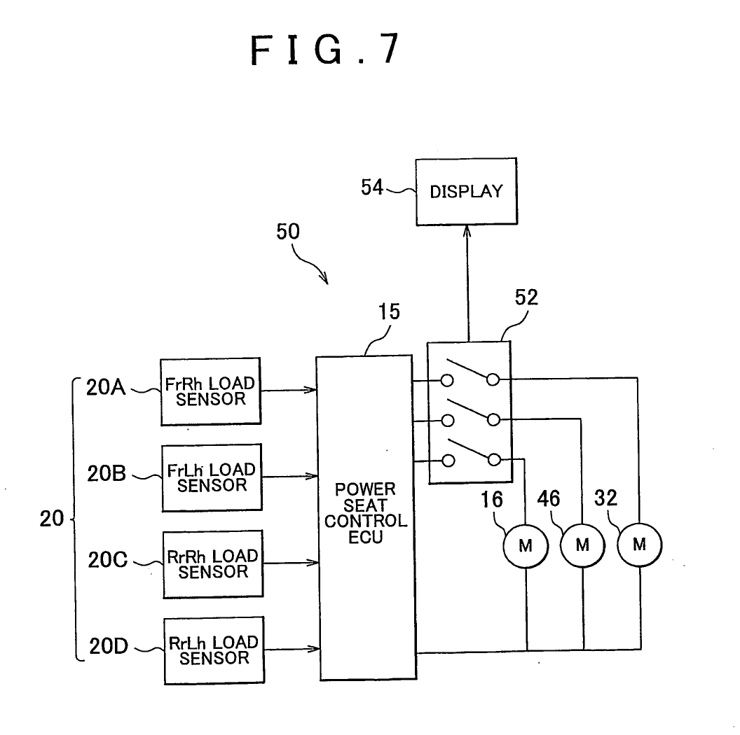

FIG. 7 is a block diagram showing a construction of a vehicular seat operation device 50 in accordance with the second embodiment of the invention. The same construction as in the first embodiment will be described with the same reference characters

The vehicular seat control device 50 in accordance with this embodiment includes a power seat control ECU 15 that controls the various position adjustments of a vehicular seat 10. The vehicular seat control device 50 adjusts the position of the vehicular seat 10 in various directions and the like by controlling the shifts of various shift mechanisms of the vehicular seat 10 via the power seat control ECU 15.

A forward-rearward shift motor 16, an up-down shift motor 46 and a reclining motor 32 are connected to the power seat control ECU 15. The power seat control ECU 15 controls the forward-rearward shift of the vehicular seat 10 by controlling the driving of the forward-rearward shift motor 16, and controls the upward-downward shift of the vehicular seat 10 by controlling the driving of the up-down shift motor 46, and controls the reclining angle of the vehicular seat 10 by controlling the driving of the reclining motor 32.

Furthermore, a mode change switch 52 for permitting the driving of various motors in order to perform the shifting adjustment of the vehicular seat 10 is connected to the power seat control ECU 15. The mode change switch 52 includes a number of switches that corresponds to the adjustment mechanisms. When one of the switches is exclusively turned on, a corresponding mode (one of a forward-rearward shift mode, a upward-downward shift mode, and a reclining mode in this embodiment) is entered for the shifting adjustment of corresponding portions. In the case where all the switches are off, the shifting adjustment of the vehicular seat 10 is prohibited as in the fix mode in the first embodiment.

A display 54 that displays the state of operation of each of the switches of the mode change switch 52 is connected to the mode change switch 52.

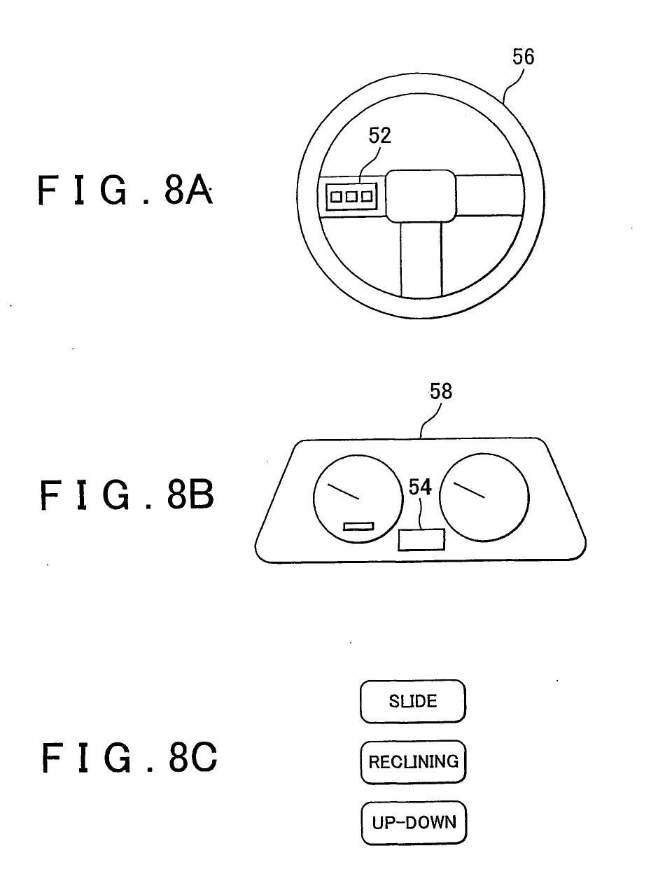

For example, the mode change switch 52 may be provided on a spoke portion of a steering wheel 56 as shown in FIG. 8A, and the display 54 may be provided in a combination meter 58 as shown in FIG. 8B. The provision of the mode change switch 52 on the steering wheel 56 in this manner makes it possible for an occupant to easily recognize a switch to operate. The provision of the display 54 in the combination meter 58 makes it possible for an occupant to easily check the state of change of mode. FIG. 8C shows an example in which a state in which the mode change switch 52 has been operated is displayed. In FIG. 8C, “SLIDE” represents the forward-rearward shift mode, the “RECLINING” represents the reclining mode, and the “UP-DOWN” represents the upward-downward shift mode.

Furthermore, a plurality of load sensors 20 are connected to the power seat control ECU 15, similarly to the first embodiment. The load sensors 20 are provided on individual seat brackets 36 similarly to the first embodiment. In the second embodiment, four load sensors 20 are provided. The four load sensors 20 are an FrRh load sensor 20A provided on the seat bracket 36 disposed at a front right-hand side relative to the vehicle, an FrLh load sensor 20B provided on the vehicle front left-hand side seat bracket 36, an RrRh load sensor 20C provided on the vehicle rear right-hand side seat bracket 36, and an RrLh load sensor 20D provided on the vehicle rear left-hand side seat bracket 36.

Each load sensor 20, which may be, for example, a strain gage or the like, detects the load applied to a corresponding one of the seat brackets 36, and outputs a result of detection to the power seat control ECU 15. Incidentally, the load sensors 20 for this use may be the ones that are provided for the use for the control of an airbag device. Such dual-purpose use of the sensors allows inexpensive construction of the vehicular seat operation device. Besides, various types of load sensors may be applied. Examples of applicable types of load sensors include a type in which the load distribution on the seat base is detected by a load distribution sensor that is provided in the seat cushion for detecting the load distribution, a type in which the load is detected by a plurality of load sensors provided between the seat rails 34 and the vehicular seat 10 for detecting the load as in the embodiment, etc.

The power seat control ECU 15 calculates a change in the distribution of the load applied to the seat cushion on the basis of the results of detection from the load sensors 20, and controls the shifting adjustment of the vehicular seat 10 in accordance with the calculated change in the load distribution.

For example, let it assumed that the load distribution during an initial state is substantially the same result of detection being obtained from the load sensors 20 as shown in FIG. 3A. Then, if the load distribution in the forward side of the vehicular seat 10 is greater as shown in FIG. 3B and the mode change switch 52 has been operated to the forward-rearward shift mode, the power seat control ECU 15 determines that the vehicular seat 10 is to be shifted to the vehicle forward side, and controls the forward-rearward shift motor 16 so as to shift the vehicular seat 10 to the vehicle forward side. If the load distribution in the forward side of the vehicular seat 10 is greater and the mode change switch 52 has been operated to the upward-downward shift mode, the power seat control ECU 15 determines that the vehicular seat 10 is to be shifted to the vehicle upward side, and controls the up-down shift motor 46 so as to shift the vehicular seat 10 to the vehicle upward side. If the load distribution in the forward side of the vehicular seat 10 is greater and the mode change switch 52 has been operated to the reclining mode, the power seat control ECU 15 determines that the vehicular seat 10 is to be shifted in such a direction as to stand the seatback upright, and controls the reclining motor 32 so as to shift the seatback of the vehicular seat 10 in the standing-up direction.

Conversely, if the load distribution in the rearward side of the vehicular seat 10 is greater and the mode change switch 52 has been operated to the forward-rearward shift mode, the power seat control ECU 15 determines that the vehicular seat 10 is to be shifted to the vehicle rearward side, and controls the forward-rearward shift motor 16 so as to shift the vehicular seat 10 to the vehicle rearward side. If the load distribution in the rearward side of the vehicular seat 10 is greater and the mode change switch 52 has been operated to the upward-downward shift mode, the power seat control ECU 15 determines that the vehicular seat 10 is to be shifted to the vehicle downward side, and controls the up-down shift motor 46 so as to shift the vehicular seat 10 to the vehicle downward side. If the load distribution in the vehicle rearward side of the vehicular seat 10 is greater and the mode change switch 52 has been operated to the reclining mode, the power seat control ECU 15 determines that the vehicular seat 10 is to be shifted in such a direction as to lay the seatback down, and controls the reclining motor 32 so as to shift the seatback of the vehicular seat 10 in a seatback laying-down direction.

That is, the shifting of the vehicular seat 10 in the front-rear direction and the up-down direction as well as in the reclining angle can be controlled in accordance with the state of the mode change switch 52, depending on how an occupant applies load to the vehicular seat 10. Thus, the operation for adjusting the vehicular seat 10 can easily be performed.

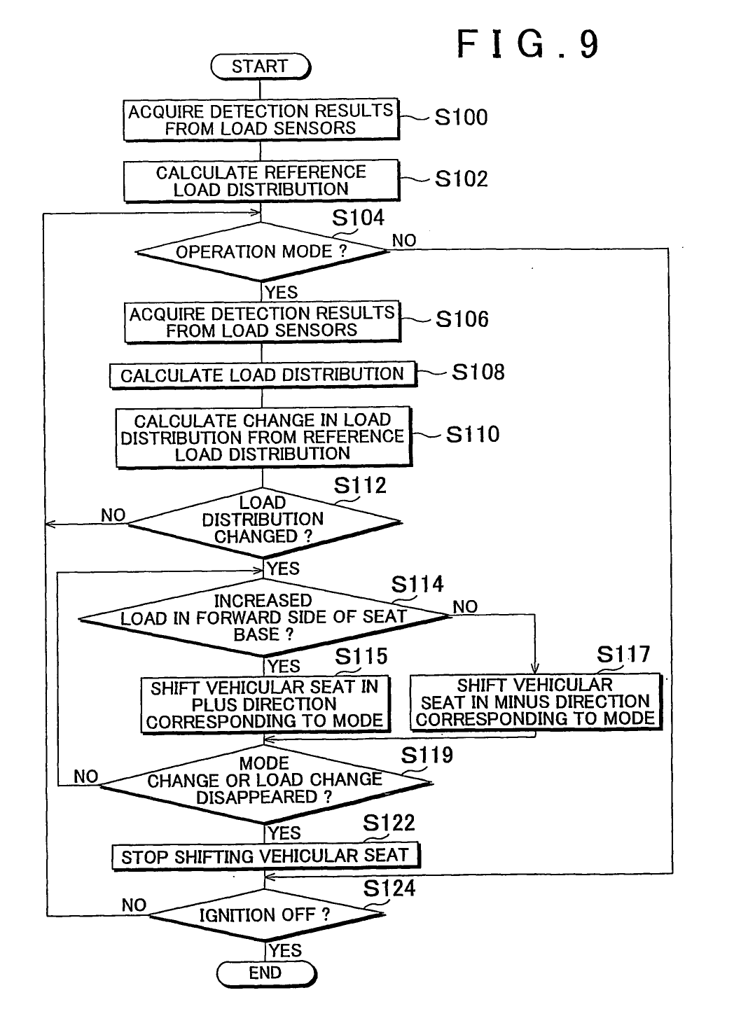

Next, processes performed by the power seat control ECU 15 of the vehicular seat operation device 50 in accordance with the second embodiment of the invention constructed as described will be described in detail. FIG. 9 is a flowchart showing an example of the flow of a process performed by the power seat control ECU 15 of the vehicular seat operation device 50 in accordance with the second embodiment of the invention. Although in the flowchart of FIG. 9, it is assumed that the process starts when an ignition switch (not shown) is turned on, this is not restrictive. For example, the process may start when an occupant is seated on the vehicular seat 10. In addition, in the description below, the vehicle forward direction, the vehicle upward direction and the seatback standing-up direction are defined as plus directions, and the vehicle rearward direction, the vehicle downward direction and the seatback laying-down direction are defined as minus directions. Besides, the same processes as in the first embodiment will be described with the same reference characters.

When an occupant turns on the ignition switch, the power seat control ECU 15, firstly in step 100, acquires detection results from the load sensors 20, and then proceeds to step 102.

In step 102, the power seat control ECU 15 calculates a reference load distribution, and then proceeds to step 104. Specifically, there are cases where the detection results from the load sensors 20 are not substantially the same and the load distribution that serves as a reference may vary depending on the present angle of the seatback of the vehicular seat 10 or the like. Therefore, on the basis of the detection results from the load sensors 20, the power seat control ECU 15 calculates a distribution of the loads applied to the seat cushion of the vehicular seat 10 that serves as a reference distribution. For example, in the example case shown FIGS. 3A to 3C, the load distribution that serves as a reference is substantially the same detection result being obtained from the load sensors 20 as shown in FIG. 3A.

Next in step 104, the power seat control ECU 15 determines whether or not the present mode is the operation mode. This determination is carried out by determining whether or not the mode change switch 52 has been operated by the occupant so as to command the operation mode. If a negative determination is made in this step, the process proceeds to step 124. If an affirmative determination is made, the process proceeds to step 106. In this embodiment, it is determined whether or not any one of the operation modes, that is, the forward-rearward shift mode, the upward-downward shift mode and the reclining mode, has been selected. Furthermore, in the case where an operation mode has been commanded, the display 54 is caused to display which one of the operations mode has been selected, in accordance with the state of the mode change switch 52, so that the occupant can be informed of the content of the operation mode.

In step 106, the power seat control ECU 15 acquires detection results from the load sensors 20, and then proceeds to step 108.

In step 108, the power seat control ECU 15 calculates a load distribution, and then proceeds to step 110.

In step 110, the power seat control ECU 15 calculates a change in the load distribution from the reference load distribution, and then proceeds to step 112. For example, the change in the load distribution is calculated by the power seat control ECU 15 finding a difference between the reference load distribution calculated in step 102 and the load distribution calculated in step 108.

In step 112, the power seat control ECU 15 determines whether or not there is a change in the load distribution. If a negative determination is made in this step, the process returns to step 104, and the foregoing process is repeated. If an affirmative determination is made, the process proceeds to step 114.

In step 114, the power seat control ECU 15 determines whether or not the change in the load distribution is a load increase in the forward side of the seat base. If an affirmative determination is made in this step, the process proceeds to step 115. If a negative determination is made, it is determined that the change in the load distribution is a load increase in the rearward side of the seat base, and the process proceeds to step 117.

In step 115, the vehicular seat 10 is shifted in the plus direction corresponding to the operation mode which is operated. Then, the process proceeds to step 119. Specifically, if the present operation mode is the forward-rearward shift mode, the power seat control ECU 15 controls the driving of the forward-rearward shift motor 16 so as to shift the vehicular seat 10 to the vehicle forward side. If the present operation mode is the upward-downward shift mode, the power seat control ECU 15 controls the driving of the up-down shift motor 46 so as to shift the vehicular seat 10 to the vehicle upward side. If the present operation mode is the reclining mode, the power seat control ECU 15 controls the driving of the reclining motor 32 so as to shift the seatback of the vehicular seat 10 in the seatback standing-up direction.

On the other hand, in step 117, the vehicular seat 10 is shifted in the minus direction. Then, the process proceeds to step 119. Specifically, if the present operation mode is the forward-rearward shift mode, the power seat control ECU 15 controls the driving of the forward-rearward shift motor 16 so that the vehicular seat 10 is shifted to the vehicle rearward side. If the present operation mode is the upward-downward shift mode, the power seat control ECU 15 controls the driving of the up-down shift motor 46 so that the vehicular seat 10 is shifted to the vehicle downward side. If the present operation mode is the reclining mode, the power seat control ECU 15 controls the driving of the reclining motor 32 so that the seatback of the vehicular seat 10 is shifted in the seatback laying-down direction.

Incidentally, as for the determination regarding the load increase in the forward side of the seat base in the step 114, it may be determined whether or not, for example, the difference between the load distribution in the vehicle forward side of the vehicular seat 10 and the load distribution in the rearward side thereof is greater than or equal to a predetermined value. This makes it possible to prevent the chattering of the control in which a shift of the vehicular seat in the plus direction corresponding to the operation mode and a shift thereof in the minus direction corresponding to the operation mode are repeated in a short time.

Subsequently in step 119, the power seat control ECU 15 determines whether or not the mode change or the load change has discontinued. Specifically, the power seat control ECU 15 determines whether or not the position of the vehicular seat 10 has been set and the mode change switch 52 has been switched to the fix mode or another operation mode, or whether or not the change in the load distribution has disappeared and the occupant has stopped shifting load. If a negative determination is made, the process returns to step 114, and the foregoing process is repeated. When an affirmative determination is made in step 119, the process proceeds to step 122, in which the power seat control ECU 15 stops the driving of the motor whose driving is being controlled by the power seat control ECU 15, so that the shift of the vehicular seat 10 stops.

Then in step 124, the power seat control ECU 15 determines whether or not the ignition switch has been turned off. If a negative determination is made in this step, the process returns to step 104, and the foregoing process is repeated. If an affirmative determination is made, the series of processes ends.

Thus, the vehicular seat operation device 50 in accordance with the embodiment is able to shift the vehicular seat 10 in various directions merely by an occupant shifting load toward the vehicle front or rear side while being seated. Therefore, the position adjustment of the vehicular seat 10 can easily be performed.

Furthermore, the vehicular seat operation device 50 shifts the vehicular seat 10 in response to a change in the load applied to the vehicular seat 10 only when the mode change switch 52 is operated to select an operation mode. While the mode change switch 52 is set for the fix mode, the position adjustment of the vehicular seat 10 is prohibited. Therefore, the vehicular seat operation device 50 can prevent the position adjustment of the vehicular seat 10 being performed in response to a load change or the like during the running of the vehicle. Beside, even in the case where the operation mode has been selected by operating the mode change switch 52, the mode may be changed to the fix mode if the mode change switch 52 has not been operated for a predetermined time or longer. In this case, after the vehicular seat 10 is adjusted, the mode can be automatically changed to the fix mode. Thus, the switch operation at the time of adjustment of the vehicular seat 10 further improves.

Furthermore, since it is not necessary that the vehicular seat 10 be provided with a switch or the like for commanding a direction of the position adjustment of the vehicular seat 10, the degree of freedom in the design of the vehicular seat 10 can be improved.

Therefore, as in the first embodiment, it is possible to improve the degree of freedom in the design of the vehicular seat and also realize the operability that suits an occupant's intention.

Although in the foregoing embodiments, the load sensors 20 are provided at four sites, this is not restrictive. For example, load sensors may be provided at two sites, that is, on front and rear sides relative to the vehicle. Furthermore, although the load sensors 20 are provided on the seat brackets 36, this is not restrictive. On the contrary, the load sensors 20 may be provided at any locations as long as the load shift of an occupant can be detected. For example, load sensors may be provided in the seat cushion that forms a seat base of an occupant or the like so as to detect the occupant's load distribution.

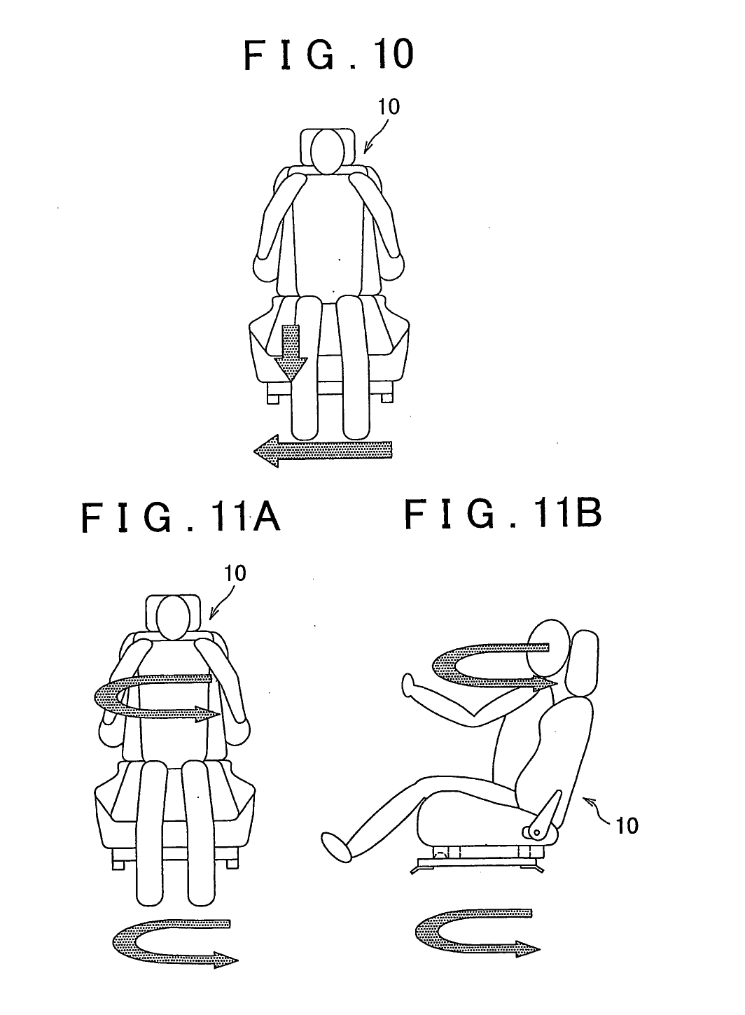

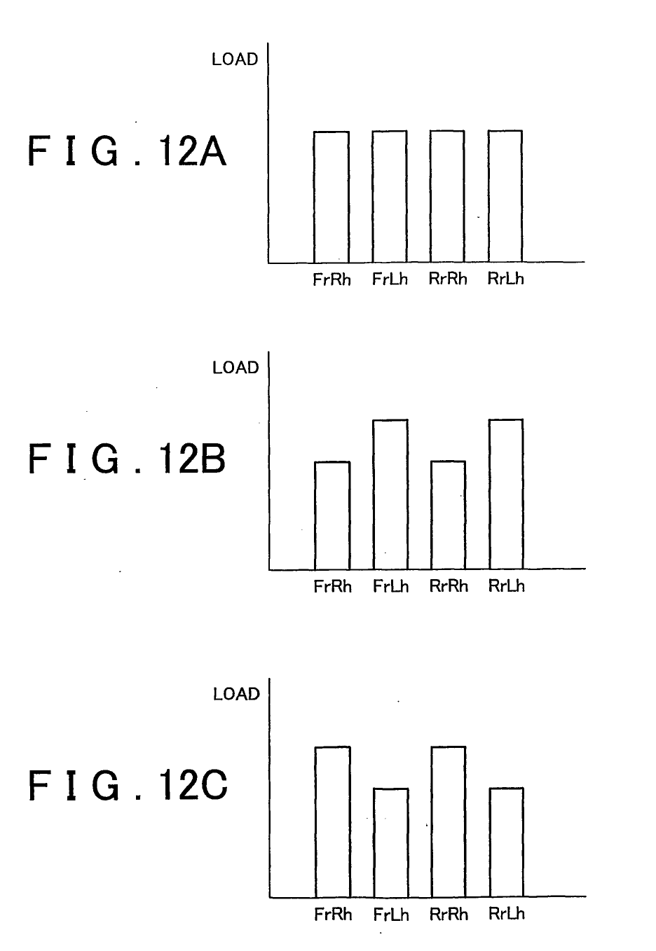

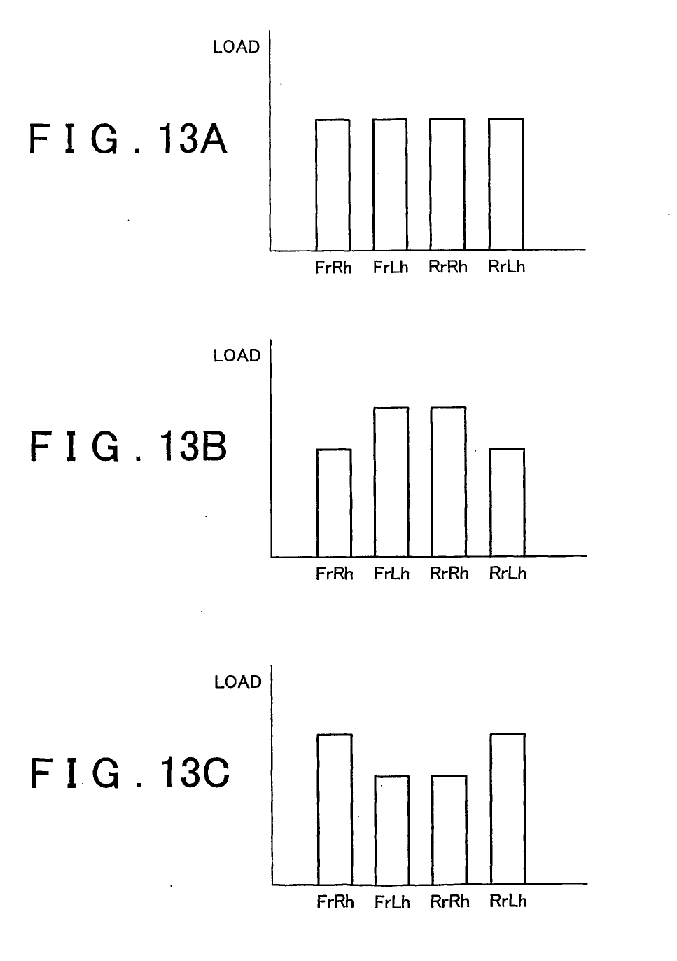

Furthermore, although in the foregoing embodiments, the shifting of the vehicular seat 10 in the vehicle front-rear direction and the vehicle up-down direction as well as in the reclining angle is controlled in response to a shift of the load of an occupant in the vehicle front-rear direction, this is not restrictive. On the contrary, another adjustment mechanism may be provided so as to change the state of the vehicular seat 10 upon detection of a change in the load distribution. For example, as shown in FIG. 10, the vehicular seat 10 may be shifted and controlled in the vehicle left-right direction (the vehicle rightward direction in FIG. 10) when an occupant shifts the load in the vehicle left-right direction (the vehicle rightward direction in FIG. 10). Furthermore, as shown in FIGS. 11A and 11B, the vehicular seat 10 may be rotated and controlled in the vehicle left-right direction (toward the left of the vehicle in FIGS. 11A and 11B) when an occupant shifts the load by twisting the occupant's body (twisting the occupant's body toward the left side of the vehicle in FIGS. 11A and 11B). Concretely, in the case where the load shift in the vehicle left-right direction is adopted, the vehicular seat 10 is shifted toward the vehicle left side if the load distribution changes from the initial-state load distribution (FIG. 12A) so that the load distribution in the vehicle left side increases as shown in FIG. 12B. If the load distribution changes so that the load distribution in the vehicle right side increases as shown in FIG. 12C, the vehicular seat 10 is shifted and controlled toward the vehicle right side. In the case where the load shift made by a twist of an occupant body is adopted, the vehicular seat 10 is rotated toward the vehicle right side if the load distribution changes from the initial-state load distribution (FIG. 13A) so that the loads on the vehicle front left-hand side and the vehicle rear right-hand side increase as shown in FIG. 13B. If the load distribution changes so that the loads on the vehicle front right-hand side and the vehicle rear left-hand side increase as shown in FIG. 13C, the vehicular seat 10 is rotated toward the vehicle left side.

Furthermore, although in the second embodiment, the position of the vehicular seat 10 is adjusted in the vehicle front-rear direction and the vehicle up-down direction as well as in the reclining angle, this is not restrictive. For example, the invention may also be applied to a case where a change is to be made in at least one of the position of the vehicular seat in the vehicle front-rear direction, the position of the vehicular seat in the vehicle left-right direction, the position of the vehicular seat in the vehicle up-down direction, the pivot angle of the vehicular seat, the hold angle of the side support of the vehicular seat, and the inclination angle of the seatback of the vehicular seat.

Furthermore, in the second embodiment, the mode change switch 52 is provided with a number of switches that corresponds to the adjustment mechanisms. However, the mode change switch may be provided with a push-button type switch, and the mode may be changed according to the number of times that the switch has been pushed. Alternatively, the mode change switch may be provided with a rotary type switch, and the mode may be changed according to the position to which the switch is rotated, or the number of rotations of the switch.

1. A vehicular seat operation device comprising:
a change device that changes a state of a vehicular seat;
a permission device that permits a change to be made by the change device;
a detection device that detects a change in a load distribution of load that acts on the vehicular seat; and
a control device that controls the change device by a predetermined change method corresponding to the change in the load distribution if the change by the change device has been permitted by the permission device.

2. The vehicular seat operation device according to claim 1, wherein the detection device detects a load shift state of a seated occupant as the change in the load distribution.

3. The vehicular seat operation device according to claim 1, wherein the control device controls the change device if the load distribution becomes such that a difference between the load acting on a predetermined site in the vehicular seat and the load acting on another site is greater than or equal to a predetermined value.

4. The vehicular seat operation device according to claim 1, wherein the detection device includes a load distribution sensor that is disposed in a seat base of the vehicular seat and that detects the load distribution, and a computation device that computes the change in the load distribution on the seat base based on a detection result from the load distribution sensor.

5. The vehicular seat operation device according to claim 1, wherein the detection device includes a plurality of load sensors that are disposed below an seat base of the vehicular seat and that detect load, and a computation device that computes the change in the load distribution of loads occurring on the plurality of load sensors based on detection results from the load sensors.

6. The vehicular seat operation device according to claim 1, wherein the change device changes at least one of a position of the vehicular seat in a vehicle front-rear direction, a position of the vehicular seat in a vehicle left-right direction, a position of the vehicular seat in a vehicle up-down direction, a pivot angle of the vehicular seat, a hold angle of a side support of the vehicular seat, and an inclination angle of a seatback of the vehicular seat.

7. The vehicular seat operation device according to claim 1, further comprising a setting device that sets a reference value of the load distribution, wherein the detection device detects the change in the load distribution from the reference value.

8. The vehicular seat operation device according to claim 1, wherein
the change device includes a first change device and a second change device that shift the vehicular seat in one method and another method that is different from the one method, respectively; and
the permission device selects one of the first change device and the second change device, and permits the selected one of the first change device and the second change device to shift the vehicular seat.

9. The vehicular seat operation device according to claim 8, further comprising a display device that indicates that shifting of the vehicular seat by the first change device has been permitted if the permission device has selectively permitted the first change device to shift the vehicular seat.

10. The vehicular seat operation device according to claim 1, wherein the state of the vehicular seat that the change device changes is a set position of the vehicular seat.

11. The vehicular seat operation device according to claim 1, wherein if the permission device is not operated for a predetermined time after the permission device has permitted the change device to change the state of the vehicular seat, the permission device prohibits the state of the vehicular seat from being changed.

12. The vehicular seat operation device according claim 1, wherein the control device controls the change device to change the state of the vehicular seat only when the change by the change device has been permitted by the permission device.

13. A vehicular seat operation method comprising:
calculating a reference load distribution based on loads acting on a vehicular seat;
determining whether or not a change of a set position of the vehicular seat has been permitted; and
determining whether or not an amount of change in the load distribution calculated relative to the reference load distribution is greater than a predetermined value,
wherein if it is determined that the change has been permitted and that the amount of change in the load distribution is greater than the predetermined value, the vehicular seat is shifted in a predetermined direction that corresponds to a pattern of the change in the load distribution calculated relative to the reference load distribution.

14. The vehicular seat operation method according to claim 13, further comprising:
determining whether or not which of a plurality of modes that each define a shift manner of the vehicular seat has been selected if it is determined that the change in the set position of the vehicular seat has been permitted; and
shifting the vehicular seat in the predetermined direction that corresponds to the pattern of the calculated change in the load distribution by controlling a change device provided for the vehicular seat which has been associated in correspondence to the mode determined to have been selected.
